(19) United States
(12) Patent Application Publication
(10) Pub. No.: US 2005/0030183 A1
(43) Pub. Date: Feb. 10, 2005

(54) Human tracer II

(76) Inventor: Charles Geryeshelias Blanc, West Palm Beach, FL (US)

Correspondence Address: CHARLES GERYESHELIAS BLANC, P. O. BOX 22403, WEST PALM BEACH, FL, 33416, US

(21) Appl. No.: 10/901,484

(22) Filed: Jul. 29, 2004

Related U.S. Application Data
(63) Continuation-in-part of application No. 10/210,485, filed on Aug. 2, 2002.

(51) Int. Cl. G08B 23/00

(52) U.S. Cl. 340/573.4

(57) ABSTRACT

The new idea is having offices nation wide called Human Tracer II Stores you walk in and fill out a form of personnal information and pay a fee you get injected with a CHIP and get bandaged like getting a blood test except you are getting a CHIP in you and your not injected into a vain but (yes inside the skin) and yes it can be injected anywere inside the Skin. the first thing a family member or a friend needs to do when a loved one is missing is to. 1) Notify the police Asap. 2) The Human Tracer II will get turned on and in matters of minutes were able to locate that child, teenager, or adult. where the police can apprehend the criminal before any violent or a criminal act is committed and it can save many human lifes. 3) Without a police report and a law enforcement agency officer present the Human Tracer II will not be turned on (No Exception).

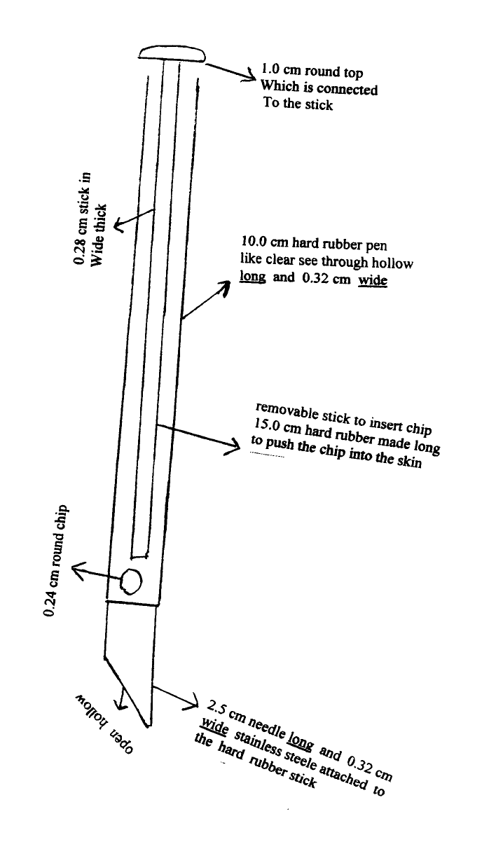

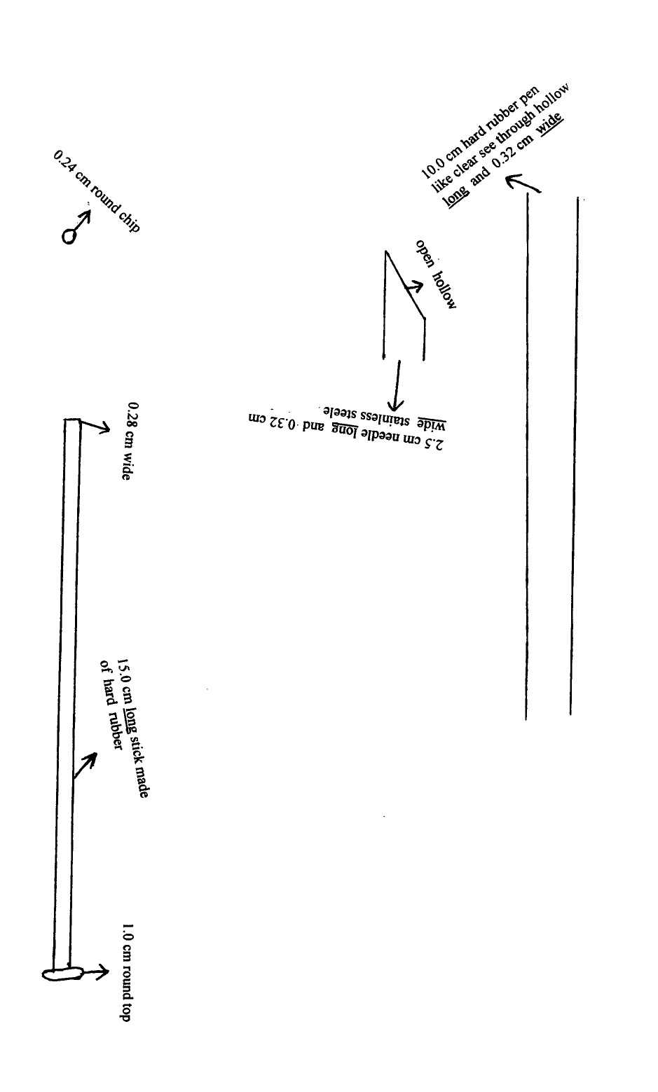

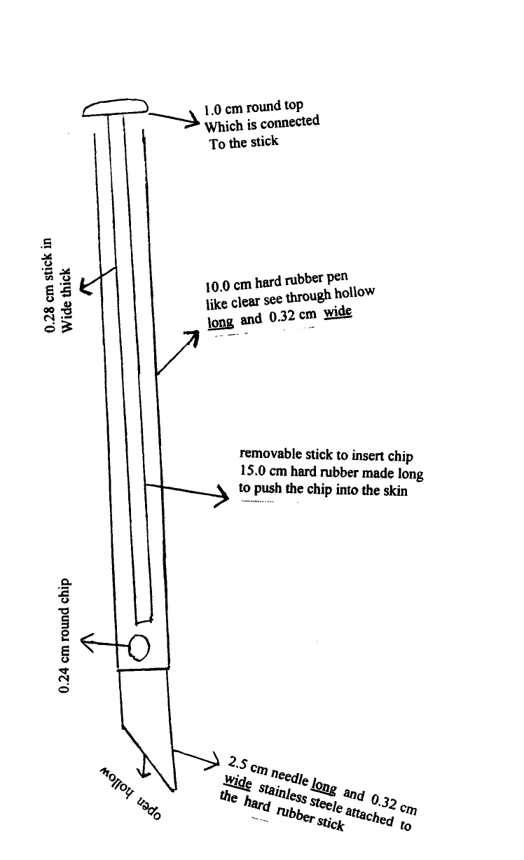

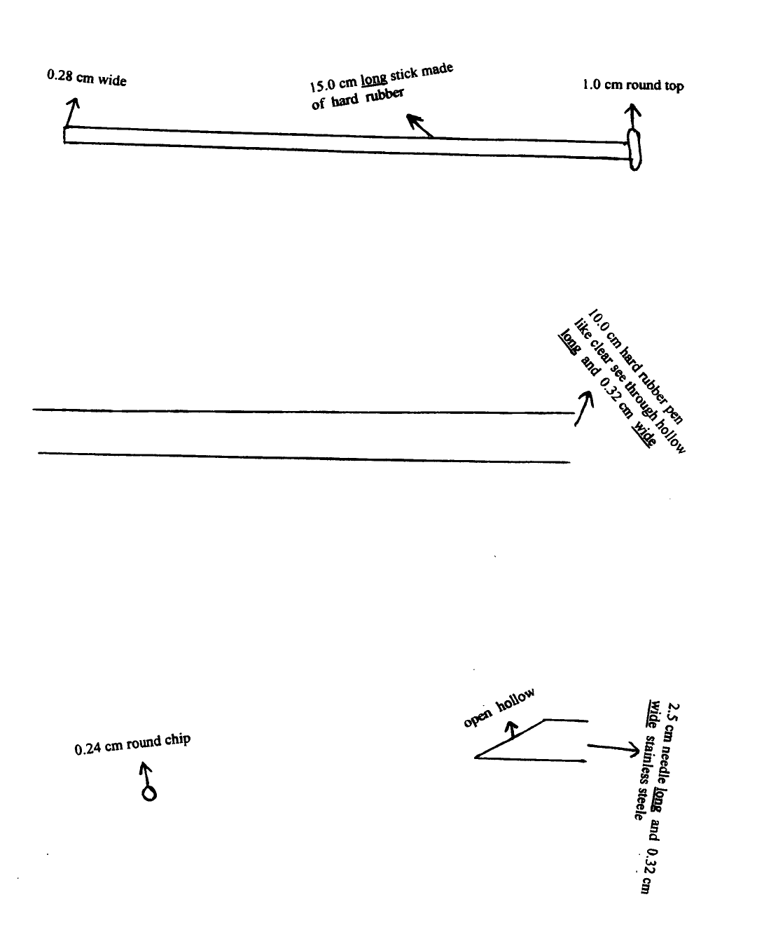

### BACKROUND OF THE INVENTION

1) 1 Animal tracker which is attached to an animal and let loose in the wild and several month down the line able to locate that animal. 2 It's also used on fish, dolphins and sharks in the ocean. 3 also used on automobiles to locate them.

### BRIEF SUMMARY OF THE INVENTION

2) 1 It's a Chi device just like the list above except it's for human and will be inserted inside the skin in order to pin point and locate children, teenagers, and adults.

2 it can be inserted into the skin using the plastic pen like with a needle attached on the tip of it which it can be disposable after each use drawing is attached.

1. What I claim is my invention is the idea of a human tracer II is for a human to have a chip inside the human skin but not into the vain but as of anywere inside the human skin as a tracking device chip to locate a missing child, teenager, or adult.
